(19) United States
(12) Patent Application Publication
(10) Pub. No.: US 2020/0213356 A1
(43) Pub. Date: Jul. 2, 2020

(54) MALWARE INSPECTION SUPPORT SYSTEM AND MALWARE INSPECTION SUPPORT METHOD

(71) Applicant: FUJITSU LIMITED, Kawasaki-shi (JP)

(72) Inventors: TORU SHIMANAKA, Yokohama (JP); Ryusuke Masuoka, Setagaya (JP); Yuichi Tashiro, Yokohama (JP)

(73) Assignee: FUJITSU LIMITED, Kawasaki-shi (JP)

(21) Appl. No.: 16/724,487

(22) Filed: Dec. 23, 2019

(30) Foreign Application Priority Data
Dec. 27, 2018 (JP) 2018-245204

(51) Int. Cl. H04L 29/06

(52) U.S. Cl. CPC H04L 63/1491; H04L 63/1425; H04L 63/1416

(57) ABSTRACT

A malware inspection support system includes one or more memories, and one or more processors coupled to the one or more memories and the one or more processors configured to, when a first terminal belonging to a first system is infected with malware, in response to receiving, from the first terminal, a first packet destined for a second terminal, perform determination of whether the first packet satisfies a specific condition, when it is determined that the first packet satisfies the specific condition, change a destination address of the first packet to an address of a third terminal belonging to a second system, and transmit the changed first packet to the third terminal.

### CROSS-REFERENCE TO RELATED APPLICATION

This application is based upon and claims the benefit of priority of the prior Japanese Patent Application No. 2018-245204, filed on Dec. 27, 2018, the entire contents of which are incorporated herein by reference.

### FIELD

The embodiments discussed herein are related to malware inspection support techniques.

### BACKGROUND

In recent years, cyberattacks, such as unauthorized access via a network, have raised serious concerns. To deal with such cyberattacks, it is important to collect cyber threat intelligence (CTI) in which information on attackers, purposes, attack techniques and methods, and so on obtained by observing the cyberattacks is summarized in a report or the like. As existing techniques for collecting the CTI, unauthorized access information systems that monitor unauthorized access to a honey net and collect unauthorized access information are known.

Related techniques are disclosed in, for example, Japanese Laid-open Patent Publication No. 2008-172548 and Japanese Laid-open Patent Publication No. 2012-212391.

### SUMMARY

According to an aspect of the embodiments, a malware inspection support system includes one or more memories, and one or more processors coupled to the one or more memories and the one or more processors configured to, when a first terminal belonging to a first system is infected with malware, in response to receiving, from the first terminal, a first packet destined for a second terminal, perform determination of whether the first packet satisfies a specific condition, when it is determined that the first packet satisfies the specific condition, change a destination address of the first packet to an address of a third terminal belonging to a second system, and transmit the changed first packet to the third terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a system;

FIG. 2 is a block diagram illustrating a functional configuration of a communication device according to an embodiment;

FIG. 3 is a flowchart illustrating an example of operations of a communication device according to an embodiment;

FIG. 4 is a diagram illustrating operations in a normal mode and in a deception mode;

FIG. 5 is a diagram illustrating communication in a normal mode;

FIG. 6 is a diagram illustrating communication in a deception mode;

FIG. 7 is a diagram illustrating an example of an isolation procedure; and

FIG. 8 is a block diagram illustrating an example of a hardware configuration of an information processing device according to an embodiment.

### DESCRIPTION OF EMBODIMENTS

With the exiting techniques mentioned above, however, unauthorized access is switched all at once into the honey net. This raises a problem in that, due to inconsistencies of information or the like among nodes in the honey net, switching into the honey net is detected in some cases. For example, if an attacker is aware of switching into the honey net, the attacker interrupts the attack, which makes it difficult to continuously collect unauthorized access information.

Hereinafter, a malware inspection support program, a malware inspection support method, and a malware inspection support system according to embodiments will be described with reference to the accompanying drawings. In embodiments, the same reference numerals are used for a configuration having the same functions, and repetitive description is omitted. A malware inspection support program, a malware inspection support method, and a malware inspection support system described in the following embodiments are merely exemplary and are not intended to limit embodiments. The following embodiments may be combined as appropriate to the extent not inconsistent therewith.

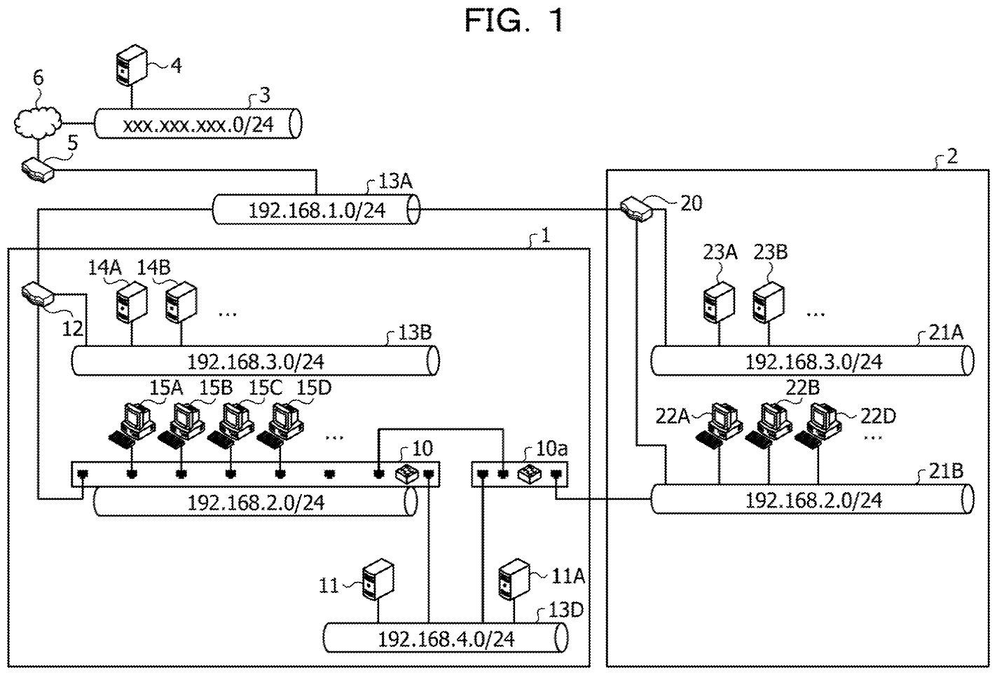

FIG. 1 is a diagram illustrating an example of a configuration of a system. As illustrated in FIG. 1, a system according to an embodiment includes a company network system 1 in a company or the like and a honey network system 2 in which the network configuration of the company network system 1 is mimicked. The company network system 1 is an example of a first system and the honey network system 2 is an example of a second system.

The company network system 1 is coupled to an external network 3 with a classless inter-domain routing (CIDR) notation of, for example, xxx.xxx.xxx.0/24 via a network address translation (NAT) router 5 and the Internet 6. The external network 3 includes a command and control (C&C) server 4 that plays a role of, for example, issuing an instruction to a terminal in the company network system 1 infected with malware to control the terminal.

The company network system 1 includes an OpenFlow switch 10, an OpenFlow controller 11, a storage device 11A, a NAT router 12, servers 14A, 14B, . . . and terminals 15A, 15B, 15C, . . . .

The OpenFlow switch 10, 10a is a network switch that relays and forwards data between devices coupled to ports under control of the OpenFlow controller 11, and is an example of a communication device. Hereinafter, the OpenFlow switch 10, 10a may be referred to as the OpenFlow switch 10 when the OpenFlow switches 10 and 10a are not discriminated from each other. The OpenFlow controller 11 delivers a flow table for path control, such as operations on packets under predetermined conditions, to the OpenFlow switch 10 by using an OpenFlow protocol and sets the flow table. The storage device 11A stores various types of information, such as the flow table for path control and condition information indicating conditions for the case of selectively changing destination addresses. The storage device 11A provides various types of information, such as the stored flow table and condition information, in response to a retrieval request from the OpenFlow controller 11.

The flow table and the condition information delivered to and set in the OpenFlow switch 10 by the OpenFlow controller 11 are created by setting of a network administrator or the like of the company network system 1 and are stored in the storage device 11A. In the flow table, operations, such as packet passage/interception, rewriting of media access control (MAC) addresses and Internet protocol (IP) addresses, and changing of output ports, in the fields of physical port numbers, source and destination MAC addresses, source and destination IP addresses, transmission control protocol (TCP)/user datagram protocol (UDP) port numbers, and the like are presented. In the condition information, for each of destination addresses of the servers 14A, 14B, . . . and the terminals 15A, 15B, 15C, . . . in the company network system 1, a rule on whether to perform switching into the honey network system 2 or not to perform switching into the honey network system 2, leaving the destination address intact, is presented. The OpenFlow switch 10 performs forwarding and discarding of data, rewriting of destination addresses, and the like based on the set flow table and condition information.

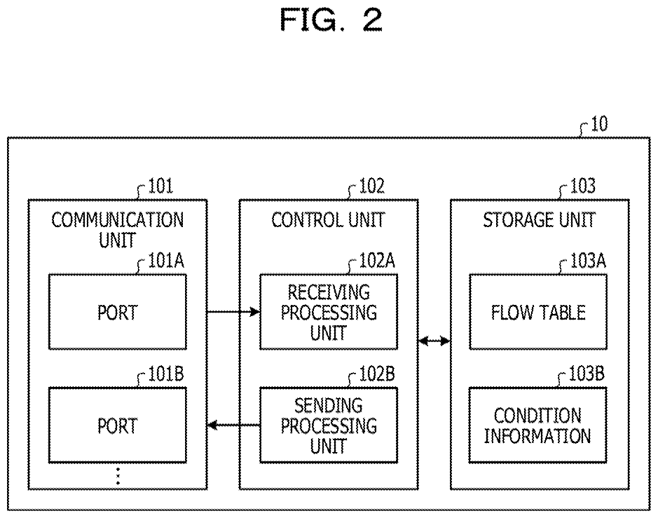

FIG. 2 is a block diagram illustrating a functional configuration of a communication device according to the embodiment, that is, the OpenFlow switch 10. As illustrated in FIG. 2, the OpenFlow switch 10 includes a communication unit 101, a control unit 102, and a storage unit 103. The communication device is an example of the malware inspection support system.

The communication unit 101 is a communication interface that performs data communication using packets with a device (for example, the terminal 15A, 15B, 15C, . . . ) coupled thereto via a port 101A, 101B, . . . under control of the control unit 102.

The control unit 102 includes a receiving processing unit 102A and a sending processing unit 102B and controls operations of the OpenFlow switch 10. For example, the control unit 102 controls forwarding and discarding of data, rewriting of destination addresses, and the like among devices coupled to the ports 101A, 101B, . . . based on a flow table 103A and condition information 103B stored in the storage unit 103.

The storage unit 103 is a storage device, for example, a hard disk drive (HDD), a semiconductor memory, or the like and stores the flow table 103A and the condition information 103B delivered by the OpenFlow controller 11.

The receiving processing unit 102A performs receiving processing to receive packets sent by a device (for example, the terminal 15A, 15B, 15C, . . . of the company network system 1, a terminal 22A, 22B, . . . of the honey network system 2, or the like) coupled to the port 101A, 101B, . . . . That is, the receiving processing unit 102A is an example of a receiving unit.

The sending processing unit 102B references the flow table 103A and the condition information 103B stored in the storage unit 103 and, based on the flow table 103A, performs sending processing to send packets received by the receiving processing unit 102A to the destination device (for example, the terminal 15A, 15B, 15C, . . . of the company network system 1, the terminal 22A, 22B, . . . of the honey network system 2, or the like). That is, the sending processing unit 102B is an example of a sending unit.

For example, the sending processing unit 102B outputs (sends) packets that meet conditions described in the flow table 103A, from the port 101A, 101B, . . . , through an operation (for example, packet passage or interception, rewriting of a MAC address and an IP address, and changing of an output port) described according to the conditions.

When the condition information 103B is set and thus a mode of selectively changing destination addresses for packets is used, the sending processing unit 102B selectively changes each of the destination addresses of packets based on the rule of the condition information 103B. For example, for a packet with a destination address for which a rule of performing switching into the honey network system 2 is presented in the condition information 103B, the sending processing unit 102B changes the destination address based on the flow table 103A. For a packet with a destination address for which a rule of not performing switching into the honey network system 2, leaving the destination address intact, is presented in the condition information 103B, the sending processing unit 102B does not change the destination address.

The NAT router 12 is a router device that translates IP addresses and the like to couple the networks 13A to 13C in the company network system 1 to the external network 3.

The network 13A is a network, for example, with a classless inter-domain routing (CIDR) notation of 192.168.1.0/24, to which the NAT router 12 in the company network system 1 and a NAT router 20 in the honey network system 2 belong. The network 13B is a network, for example, with a CIDR notation of 192.168.3.0/24, to which the servers 14A, 14B, . . . in the company network system 1 belong.

The network 13C is a network, for example, with a CIDR notation of 192.168.2.0/24, to which the terminals 15A, 15B, 15C, . . . in the company network system 1 belong. The network 13D is a network, for example, with a CIDR notation of 192168.4.0/24, to which the OpenFlow controller 11 belongs.

The OpenFlow switch 10 is coupled to the terminals 15A, 15B, 15C, . . . at the respective ports and is coupled to the network 13D and a network 21B of the honey network system 2 at predetermined ports.

The servers 14A, 14B, . . . are server devices such as Web servers belonging to the company network system 1. Hereinafter, the servers 14A, 14B, . . . may be referred to as the servers 14 if the servers 14A, 14B, . . . are not to be discriminated from one another.

The terminal 15A, 15B, 15C, . . . belongs to the company network system 1 and is an information processing device such as a personal computer (PC) used by a user. That is, the terminals 15A, 15B, 15C, . . . are examples of information processing devices belonging to the first system. Hereinafter, the terminals 15A, 15B, 15C, . . . may be referred to as the terminals 15 if the terminals 15A, 15B, 15C, . . . are not to be discriminated from one another.

The honey network system 2 includes the NAT router 20, the terminals 22A, 22B, . . . , and servers 23A, 23B, . . . .

The NAT router 20 is a router device that translates IP addresses and the like to couple the network 13A to a network 21A, 21B in the honey network system 2.

The network 21A is a network, for example, with a CIDR notation of 192.168.3.0/24, to which the servers 23A, 23B, . . . in the honey network system 2 belong. The network 21B is a network, for example, with a CIDR notation of 192.168.2.0/24, to which the terminals 22A, 22B, . . . in the honey network system 2 belong.

The terminals 22A, 22B, . . . , which belong to the honey network system 2, are information processing devices prepared so as to correspond to the terminals 15A, 15B, . . . in the company network system 1. For example, the terminals 22A, 22B, . . . are set to the same network names and IP addresses as the terminals 15A, 15B, . . . , respectively, in the network 21B of 192.168.2.0/24, which is the same notation as used for the terminal 15A, 15B, . . . . For example, the terminal 22A has the same network name and IP address as the terminal 15A, and the terminal 22B has the same network name and IP address as the terminal 15B. In terms of the MAC addresses, the terminal 22A and the terminal 15A, as well as the terminal 22B and the terminal 15B, differ from each other. Although IP addresses are presented as examples of IPv4, IPv6 may be implemented under the same concept.

The servers 23A, 23B, . . . , which belong to the honey network system 2, are server devices prepared so as to correspond to the servers 14A, 14B, . . . in the company network system 1. For example, the servers 23A, 23B, . . . are provided with the same network names and IP addresses as the servers 14A, 14B, . . . , respectively, in the network 21A of 192.168.3.0/24, which is the same notation as used for the servers 14A, 14B, . . . . For example, the server 23A has the same network name and IP address as the server 14A, and the server 238 has the same network name and IP address as the server 14B. In terms of the MAC addresses, the server 23A and the server 14A, as well as the server 23B and the server 14B, differ from each other.

In such a manner, the terminals 22A, 22B, . . . in the honey network system 2 respectively mimic the terminals 15A, 15B, . . . of the company network system 1, the servers 23A, 23B, . . . of the honey network system 2 respectively mimic the servers 14A, 14B, . . . of the company network system 1, and the honey network system 2 is a system that mimics the company network system 1.

If the user (for example, a network administrator) of the company network system 1 does not detect the terminal 15 infected with malware, the user sets the flow table 103A for performing operations in a normal mode, in which sending and receiving of packets between the company network system 1 and the honey network system 2 is interrupted, in the OpenFlow switch 10 by the OpenFlow controller 11. Thus, in the normal mode, sending and receiving of packets between the company network system 1 and the honey network system 2 is interrupted by the OpenFlow switch 10.

It is assumed that the terminal 15 infected with malware (in the present embodiment, assuming that the terminal 15C is infected with malware) is detected by a malware detection program or the like. In this case, the user sets the flow table 103A for performing operations in a deception mode, in which packets sent and received by the terminal 15C infected with malware are directed to the honey network system 2, in the OpenFlow switch 10 by the OpenFlow controller 11.

For example, the flow table 103A is set as follows.
For an address resolution protocol (ARP) frame from the terminal 22 of the honey network system 2 to the terminal 15C infected with malware, the source MAC address and the source MAC address information in the protocol are rewritten from those of the terminal 22 to those of the terminal 15.
For a neighbor discovery protocol (NDP) packet from the terminal 22 of the honey network system 2 to the terminal 15C infected with malware, the source MAC address is rewritten from that of the terminal 22 to that of the terminal 15. In the case of Neighbor Solicitation, the source MAC address information in the protocol is rewritten from that of the terminal 22 to that of the terminal 15. In the case of Neighbor Advertisement, the target MAC address information in the protocol is rewritten from that of the terminal 22 to that of the terminal 15.
For an ARP frame from the NAT router 20 of the honey network system 2 to the terminal 15C infected with malware, the source MAC address and the source MAC address information in the protocol are rewritten from those of the NAT router 20 to those of the NAT router 12.
For an NDP packet from the NAT router 20 of the honey network system 2 to the terminal 15C infected with malware, the source MAC address is rewritten from that of the NAT router 20 to that of the NAT router 12. In the case of Neighbor Solicitation, the source MAC address information in the protocol is rewritten from that of the NAT router 20 to that of the NAT router 12. In the case of Neighbor Advertisement, the target MAC address information in the protocol is rewritten from that of the NAT router 20 to that of the NAT router 12.
For an ARP frame from the terminal 15C infected with malware to the terminal 15A, 15B, . . . , the destination MAC address and the destination MAC address information in the protocol are rewritten from those of the terminal 15 to those of the terminal 22, and the ARP frame is forwarded (changing the output port) to the terminal 22A, 22B, . . . in the honey network system 2.
An ARP frame from the terminal 15C infected with malware to the NAT router 12 is copied and forwarded to the NAT router 12 and the OpenFlow switch 10a. The OpenFlow switch 10a rewrites the destination MAC address and the destination MAC address information in the protocol from those of the NAT router 12 to those of the NAT router 20.
Communication from the terminal 15C infected with malware to the terminal 15A, 15B, . . . is forwarded (changing the output port) to the terminal 22A, 22B, . . . of the honey network system 2. At this point, the destination MAC address is rewritten from that of the terminal 15A, 15B, . . . to that of the terminal 22A, 22B, . . . .
For communication from the terminal 22 of the honey network system 2 to the terminal 15C infected with malware, the source MAC address is rewritten from that of the terminal 22 to that of the terminal 15.
Communication from the terminal 15C infected with malware to another subnet (for example, the servers 14) of the company network system 1 is forwarded (changing the output port) to the NAT router 20 of the honey network system 2. At this point, the destination MAC address is rewritten from that of the NAT router 12 to that of the NAT router 20.
For communication from the server 23 of the honey network system 2 to the terminal 15C infected with malware, the source MAC address is rewritten from that of the NAT router 20 to that of the NAT router 12.
Communication destined for the external network 3 from the terminal 15C infected with malware is passed intact (the communication path is maintained as in the normal mode).

Accordingly, in the deception mode, the terminal 15C infected with malware is isolated into the honey network system 2 by the OpenFlow switch 10 and the OpenFlow switch 10a. For example, the terminal 15C infected with malware is not physically shifted from the company network system 1 to the honey network system 2 but is logically shifted as if the terminal 15C were in the honey network system 2 on the network.

In this way, the terminal 15C infected with malware is isolated into the honey network system 2, and therefore an attack using the terminal 15C as a jump server may be inhibited from extending to other devices in the company network system 1. Accordingly, the user (for example, a network administrator) of the company network system 1 may safely monitor the behavior of the terminal 15C infected with malware and may safely collect CT.

The deception mode includes a deception mode (whole) and a deception mode (part), which are determined by setting of the flow table 103A and the condition information 103B made by a user (for example, a network administrator).

The deception mode (whole) is a mode in which the condition information 103B is not set and in which all the destinations of packets for the terminal 15C infected with malware are rewritten based on the flow table 103A. The deception mode (part) is a mode in which the condition information 103B is set and in which the destination addresses of packets are each selectively replaced based on the rule of the condition information 103B.

In the deception mode (part), based on the rule of the condition information 103B, the sending processing unit 102B selectively changes each of the destination addresses of packets from the terminal 15C, where malware is detected, to an address corresponding to the server 23 or the terminal 22A, 22B, . . . belonging to the honey network system 2 and sends the packets.

For example, in the condition information 103B, for each of the destination addresses of the servers 14A, 14B, . . . and the terminals 15A, 15B, 15C, . . . in the company network system 1, a rule on whether to perform switching into the honey network system 2 or not to perform switching into the honey network system 2, leaving the destination address intact, is presented. In the condition information 103B, a rule of performing switching into the honey network system 2 (or not performing switching into the honey network system 2, leaving the destination address intact) when the characteristics of data contained in packets satisfy predetermined conditions may be presented. Examples of the characteristics of data contained in packets include communication data destined for a predetermined node, communication data related to a predetermined communication port, and communication data including a predetermined character string.

Thus, packets related to unauthorized access or the like are selectively switched into the honey network system 2 based on the rule of the condition information 103B. This may reduce the opportunities for an attacker to become aware of a mismatch of information or the like between nodes in the honey network system 2.

In the deception mode (part), when sending packets destined for the servers 14 and the terminals 158, 0.5B, from the terminal 15C, where malware is detected, without changing the destination addresses, the sending processing unit 102B may remove some of the packets to be sent and send the packets other than the removed packets. For example, the sending processing unit 102B randomly removes some of the packets to be sent without changing the destination addresses and sends the packets other than the removed packets. Thus, when the destination addresses of packets related to unauthorized access or the like are not changed, removal of some of the packets allows the packets to be frequently delivered again, allowing the transfer time to be increased.

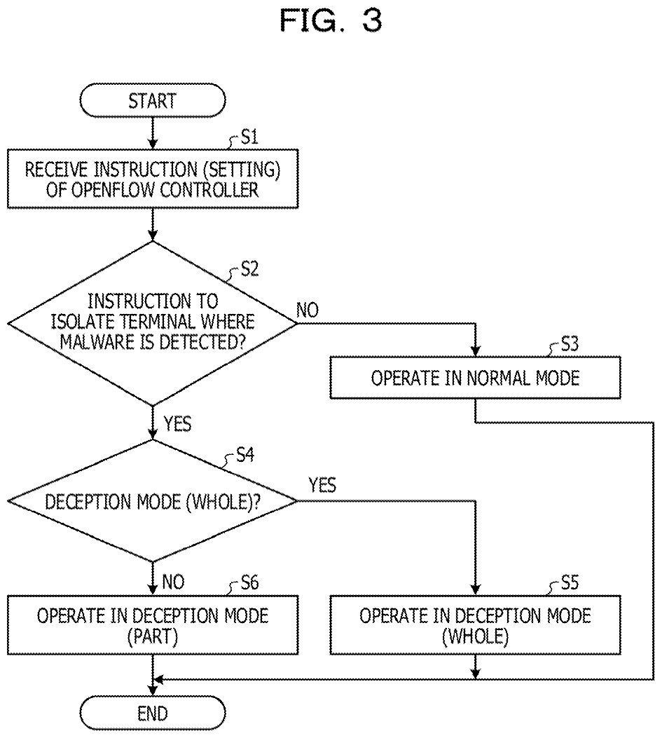

The operations of the OpenFlow switch 10, 10a will now be described in detail. FIG. 3 is a flowchart illustrating an example of operations of a communication device (the OpenFlow switch 10, 10a) according to an embodiment. As illustrated in FIG. 3, when the process begins, the control unit 102 receives an instruction (setting) of the OpenFlow controller 11 (S1) and stores the flow table 103A and the condition information 103B as instructed in the storage unit 103.

For setting of the flow table 103A, the flow table 103A that supports the normal mode and the flow table 103A for switching to the deception mode for each terminal 15 may be stored in advance in the storage unit 103. In this case, in S1, an instruction whether to maintain the normal mode or to cause a given terminal 15 to switch to the deception mode is received.

Subsequently, under the instruction received in S1, the control unit 102 determines whether there is an instruction to isolate the terminal 15 where malware is detected (for example, the terminal 15C) (S2).

For example, if the received instruction indicates the flow table 103A that supports the normal mode (S2: NO), the control unit 102 references the instructed flow table 103A and operates in the normal mode (S3).

If the received instruction indicates the flow table 103A that supports the deception mode for isolating the terminal 15C infected with malware (S2: YES), the control unit 102 proceeds to S4, where the control unit 102 references the flow table 103A as instructed and operates in the deception mode.

Subsequently, depending on whether the condition information 103B is set, the control unit 102 determines whether the operations in the deception mode are in the deception mode (whole) (S4). If the condition information 103B is not set and thus the deception mode (whole) is determined (S4: YES), based on the flow table 103A, the control unit 102 operates in the deception mode (whole), in which all the packets to be rewritten are rewritten (S5).

If the condition information 103B is set and thus the deception mode (whole) is not determined (S4: NO), the control unit 102 operates in the deception mode (part), in which rewriting based on the flow table 103A is selectively performed for each of the destination addresses based on the rule of the condition information 103B (S6). Thus, based on the rule of the condition information 103B, the control unit 102 selectively rewrites each of the destination addresses of packets from the terminal 15C, where malware is detected, to an address corresponding to the server 23 or the terminal 22A, 22B, . . . belonging to the honey network system 2.

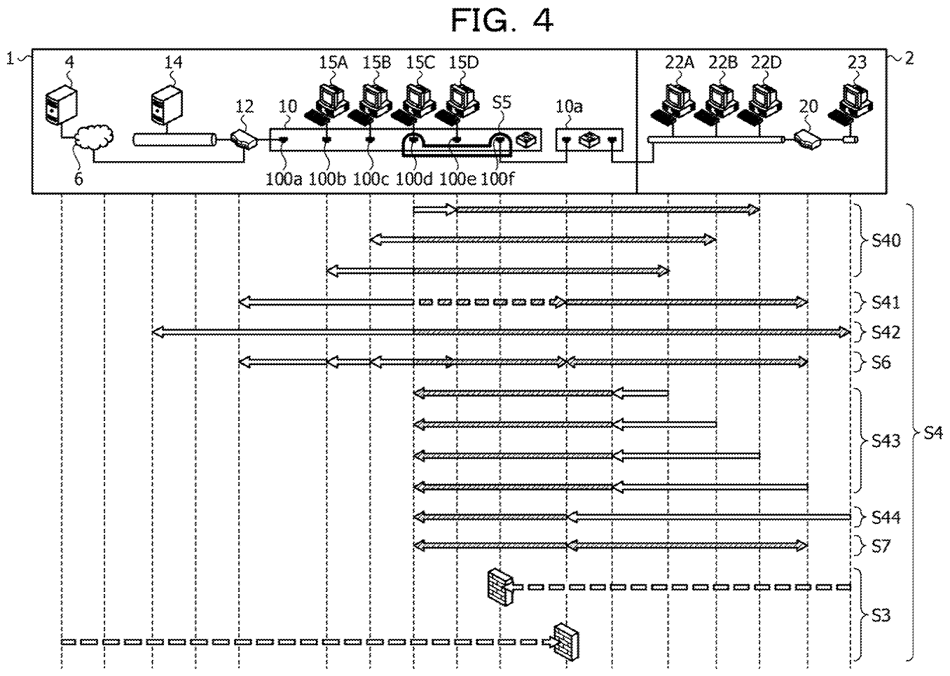

FIG. 4 is a diagram illustrating operations in the normal mode and in the deception mode. As illustrated in FIG. 4, in the normal mode (S3), sending and receiving of packets between the company network system 1 and the honey network system 2 is interrupted in the OpenFlow switch 10, 10a. Sending and receiving of packets within the company network system 1 is permitted.

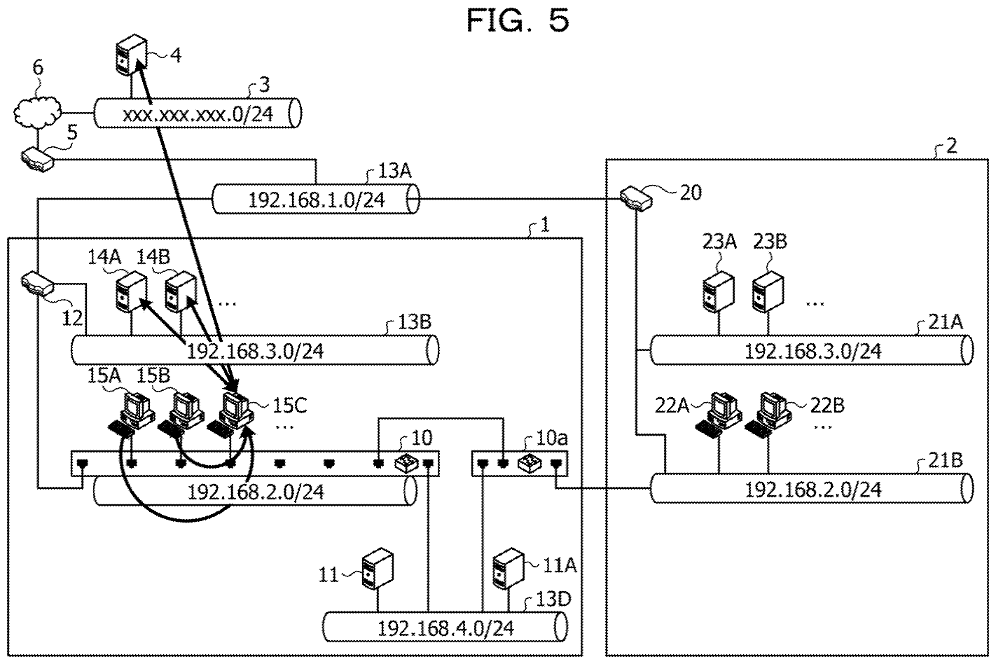

FIG. 5 is a diagram illustrating communication in the normal mode. As illustrated in FIG. 5, in the normal mode, communication, for example, from the terminal 15C to the servers 14A, 14B, . . . , the terminals 15A, 15B, . . . , and the external network 3 is permitted.

Referring back to FIG. 4, in the deception mode (S4), for communication from the terminals 22A, 22B, . . . and the NAT router 20 of the honey network system 2 to the terminal 15C infected with malware (S43), the OpenFlow switch 10, 10a rewrites the source MAC address from that of each of the terminals 22A, 22B, . . . and the NAT router 20 to that of each of the terminals 15A, 15B, . . . and the NAT router 12 and forwards the communication to the terminal 15C. For an ARP frame, the source MAC address information in the protocol is also rewritten from that of the terminals 22A, 22B, . . . and the NAT router 20 to that of the terminals 15A, 15B, . . . and the NAT router 12, respectively. For an NDP packet, in the case of Neighbor Solicitation, the source MAC address information in the protocol is rewritten from that of the terminals 22A, 22B, . . . and the NAT router 20 to that of the terminals 15A, 15B, . . . and the NAT router 12, respectively. In the case of Neighbor Advertisement, the target MAC address information in the protocol is rewritten from that of the terminals 22A, 22B, . . . and the NAT router 20 to that of the terminals 15A, 15B, . . . and the NAT router 12, respectively.

The OpenFlow switch 10, 10a forwards (changing the output ports) communication from the terminal 15C infected with malware to the terminals 15A, 15B, . . . (S40) to the terminals 22A, 22B, . . . of the honey network system 2. At this point, the destination MAC address is rewritten from that of the terminal 15A, 15B, . . . to that of the terminal 22A, 22B, . . . . For an ARP frame, the destination MAC address information in the protocol is also rewritten from that of the terminal 15A, 15B, . . . to that of the terminal 22A, 22B, . . . .

The OpenFlow switch 10, 10a copies communication from the terminal 15C infected with malware to the NAT router 12 (S41) and also forwards (with a plurality of output ports) the copied communication to the NAT router 20 of the honey network system 2. At this point, the destination MAC address is rewritten from that of the NAT router 12 to that of the NAT router 20. For an ARP frame, the destination MAC address information in the protocol is rewritten from that of the NAT router 12 to that of the NAT router 20.

The OpenFlow switch 10, 10a forwards (changing the output port) communication from the terminal 15C infected with malware to the servers 14 (S42) to the NAT router 20 of the honey network system 2. At this point, the destination MAC address is rewritten from that of the NAT router 12 to that of the NAT router 20. Thereby, the communication from the terminal 15C infected with malware to the servers 14 is forwarded to the servers 23.

For communication from the server 23 of the honey network system 2 to the terminal 15C infected with malware (S44), the OpenFlow switch 10, 10a rewrites the source MAC address from that of the NAT router 20 to that of the NAT router 12 and sends the communication to the terminal 15C.

In the deception mode (part), based on the rule of the condition information 103B, the OpenFlow switch 10, 10a selectively changes each of the destination addresses of packets from the terminal 15C, where malware is detected, to an address corresponding to the server 23 or the terminal 22A, 22B, . . . belonging to the honey network system 2.

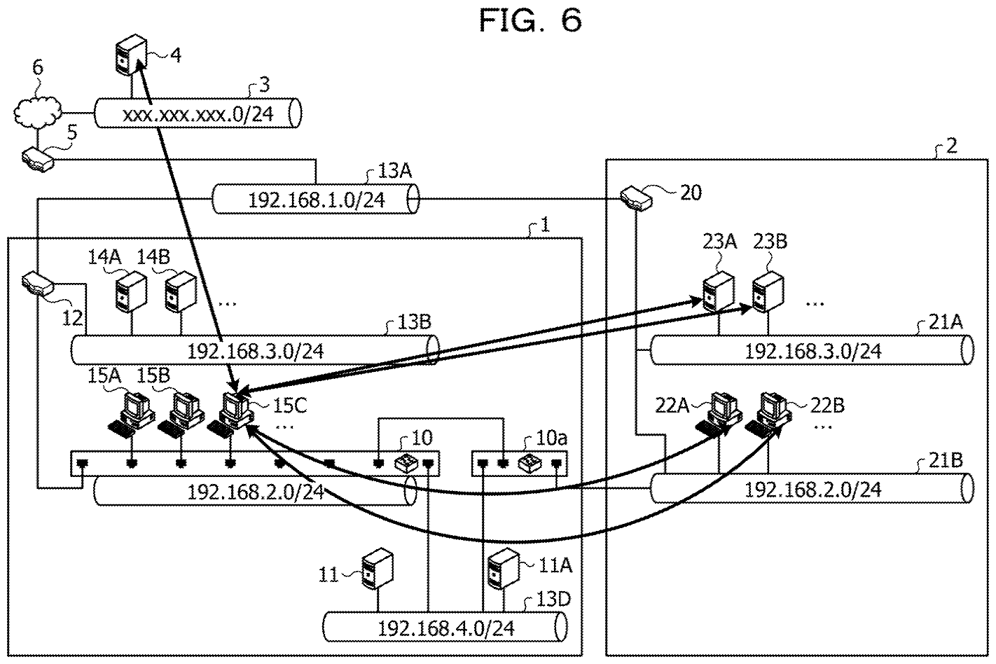

FIG. 6 is a diagram illustrating communication in the deception mode. As illustrated in FIG. 6, in the deception mode, the terminal 15C infected with malware is logically shifted as if the terminal infected with malware were in the honey network system 2 on the network.

For example, communication from the terminal 15C to the server 14A, 148 is forwarded to the server 23A, 23B, which corresponds to the server 14A, 14B, in the honey network system 2. Communication from the terminal 15C to the terminal 15A, 15B is forwarded to the terminal 22A, 22B, which corresponds to the terminal 15A, 15B, in the honey network system 2. Communication from the terminal 15C destined for the external network 3 (for example, communication to the C&C server 4) is permitted to remain unchanged.

As described above, the OpenFlow switch 10, 10a includes the receiving processing unit 102A that receives a packet sent by the information processing device (the terminal 15 or the terminal 22) belonging to the company network system 1 or the honey network system 2. The OpenFlow switch 10 includes the sending processing unit 102B. When the OpenFlow switch 10 receives packets destined for the servers 14 and the terminal 15A, 15B, . . . from the terminal 15C that belongs to the company network system 1 and where malware is detected, the sending processing unit 102B changes the destination addresses of the packets to addresses corresponding to the servers 23 and the terminal 22A, 22B, . . . belonging to the honey network system 2 and sends the packets.

Thus, the OpenFlow switch 10, 10a forwards access to the inside of the company network system 1 from the terminal 15C infected with malware in the company network system 1 to the honey network system 2, and thereby may inhibit an attack using the terminal 15 as a jump server from extending to other devices in the company network system 1. Accordingly, the user (for example, a network administrator) of the company network system 1 may safely monitor the behavior of the terminal 15C infected with malware and may safely collect CTI

When a packet destined for the terminal 15C from the terminal 22A, 22B belonging to the honey network system 2 is received, the sending processing unit 102B changes the source address (for example, the MAC address) of the packet to an address corresponding to the terminal 15A, 15B belonging to the company network system 1 and sends the packet to the terminal 15C. When a packet destined for the terminal 15C is received from the server 23 belonging to the honey network system 2 via the NAT router 20, the sending processing unit 102B changes the source address (for example, the MAC address) of the packet to an address corresponding to the NAT router 12 belonging to the company network system 1 and sends the packet to the terminal 15C. Thereby, the OpenFlow switch 10 may forward to the terminal 15C access from the terminal 22A, 22B or the server 23 belonging to the honey network system 2 to the terminal 15C.

When a packet received from the terminal 15C infected with malware in the company network system 1 is destined for the external network 3, the sending processing unit 102B sends the packet without changing the destination address of the packet. Thereby, the OpenFlow switch 10 may continue communication between the terminal 15C infected with malware and the C&C server 4. Accordingly, the user (for example, a network administrator) of the company network system 1 may monitor the behavior of the terminal 15C in a situation where communication between the terminal 15C infected with malware and the C&C server 4 continues.

When a packet destined for the terminal 15A is received from the terminal 15C where malware is detected, the sending processing unit 102B changes the destination address (for example, the MAC address) of the packet to an address corresponding to the terminal 22A, which mimics the terminal 15A, and sends the packet to the terminal 22A. Thereby, the user (for example, a network administrator) may monitor access from the terminal 15C, where malware is detected, to the inside of the honey network system 2, which mimics the company network system 1, and may safely collect CTI.

Based on the rule of the condition information 103B, the sending processing unit 102B selectively changes each of the destination addresses of packets from the terminal 15C, where malware is detected, to an address corresponding to the server 23 or the terminal 22A, 22B, . . . belonging to the honey network system 2 and sends the packets.

Thus, packets related to unauthorized access or the like are selectively switched into the honey network system 2 based on the rule of the condition information 1033. This may reduce the opportunities for an attacker to become aware of a mismatch of information or the like between nodes in the honey network system 2. Packets related to unauthorized access or the like are selectively switched to the honey network system 2, and therefore the user (for example, a network administrator) of the company network system 1 may safely monitor the behavior of the terminal 15C, where malware is detected, and may safely collect CTI.

When sending packets destined for the servers 14 and the terminal 15A, 15B, . . . from the terminal 15C, where malware is detected, without changing the destination addresses, the sending processing unit 102B removes some of the packets to be sent and sends the packets other than the reduced packets to the servers 14 and the terminal 15A, 15B, . . . . Thereby, among the packets for which switching into the honey network system 2 is not performed, some packets do not reach the destinations because of removal of the packets. This leads to frequent redelivery of packets, increasing the time required for transfer. For example, even when file transfer is performed from the terminal 15C, where malware is detected, to a node at a location other than the honey network system 2, the transfer time increases, which allows an attack to be blocked.

When the characteristics of data contained in packets destined for the servers 14 and the terminal 15A, 15B, . . . from the terminal 15C where malware is detected satisfy the conditions set in the condition information 103B, the sending processing unit 102B changes the destination addresses of the packets to addresses corresponding to the servers 23 and the terminals 22A, 22B, . . . belonging to the honey network system 2. For example, the condition information 103B sets data related to a predetermined node or communication port as a condition of changing the destination. This allows the sending processing unit 102B to selectively switch the destination addresses of packets for a node and a communication port that meet the condition of the condition information 103B.

By way of example, the condition information 103B may be set such that, for a packet for a communication port of Hypertext Transfer Protocol (HTTP), the destination is not to be changed, and for a packet for a communication port of File Transfer Protocol (FTP), the destination is to be changed. In this case, operations in which file transfer or the like through FTP is switched into the honey network system 2 and web browsing through HTTP is kept intact without being switched into the honey network system 2 may be performed. The condition information 103B may also be set such that, for a packet destined for the IP address of a server related to a web service, the destination is not to be changed, and for a packet destined for the IP address related to a database, the destination is to be changed. In this case, operations in which database viewing or the like is switched into the honey network system 2 and homepage browsing or the like is kept intact without being switched into the honey network system 2 may be performed.

The OpenFlow controller 11 adds the following content to the flow table 103A for performing operations in the deception mode and sets the flow table 103A in the OpenFlow switch 10. Thereby, the OpenFlow switch 10 deals with broadcast packets for an information processing device infected with malware (for example, the terminal 15C).

For example, the following content is added to the setting of the flow table 103A described above.

A port to which the honey network system 2 is coupled and a port to which an information processing device infected with malware (for example, the terminal 15C) is coupled are grouped.
When a broadcast packet, such as an ARP frame, is received from the information processing device infected with malware, the broadcast packet is sent to the grouped port.
When a broadcast packet is received from an information processing device (for example, the terminal 22A, 228) belonging to the honey network system 2, the source address (MAC address) of the broadcast packet is changed to the address of the information processing device (the terminal 15A, 15B corresponding to the terminal 22A, 22B) belonging to the company network system 1. In the case where the broadcast packet is ARP, the source MAC address in the protocol is changed to the MAC address of an information processing device belonging to the company network system 1. In the case of an NDP packet, the source MAC address information in the protocol is changed to the MAC address of an information processing device belonging to the company network system 1. Subsequently, the broadcast packet whose address has been changed is sent to the grouped port.

Thereby, in the deception mode, broadcast packets for an information processing device (for example, the terminal 15C) infected with malware are also isolated into the honey network system 2 by the OpenFlow switch 10. Accordingly, the user (for example, a network administrator) of the company network system 1 may safely monitor the behavior of an information processing device infected with malware and may safely collect CTI.

Details of the operations of the OpenFlow switch 10 that isolates broadcast packets for an information processing device infected with malware will be described. In a modification, it is assumed that the terminals 15A, 15B, 15C, 15D, . . . in the company network system 1 belong to the network 13C of 192.168.2.0/24. It is also assumed that the terminal 15C is a terminal infected with malware. It is also assumed that the terminals 22A, 22B, 22C, . . . , in the honey network system 2, which mimic the terminals 15A, 15B, 15D, . . . other than the terminal 15C infected with malware, belong to the network 21B of 192.168.2.0/24.

As illustrated in FIG. 4, under the setting of the flow table 103A, the control unit 102 of the OpenFlow switch 10 begins a process in the deception mode in order to deal with the terminal 15C infected with malware.

In the deception mode, in addition to S5 and S6 described above, the control unit 102 performs S5 to S7. For example, the control unit 102 groups, among ports 100a to 100f, the port 100d of the terminal 15C infected with malware and the port 100f to which the OpenFlow switch 10a on the side of the honey network system 2 is coupled, as ports belonging to the same group (S5).

When the control unit 102 receives a broadcast packet from the terminal 22A, 22B, 22C belonging to the honey network system 2 (S7), the control unit 102 changes the source address (MAC address) of the broadcast packet to the address of the terminal 15A, 15B, 15C corresponding to the terminal 22A, 22B, 22C. In the case where the broadcast packet is ARP, the source MAC address in the protocol is changed to the address of the terminal 15A, 15B, 15C corresponding to the terminal 22A, 22B, 22C. In the case of an NDP packet, the source MAC address information in the protocol is changed to the address of the terminal 15A, 15B, 15C corresponding to the terminal 22A, 22B, 22C. Subsequently, the broadcast packet whose address has been changed is sent to the grouped port. The sending processing unit 102B subsequently sends to the grouped port 100d the broadcast packet whose address has been changed.

When a broadcast packet from the terminal 15C infected with malware is received (S6), the sending processing unit 102B sends the broadcast packet to the port 100f grouped with the port 100d of the terminal 15C. At this point, the sending processing unit 102B does not send the broadcast packet to the port 100b, 100c, 100e of the terminal 15A, 15B, 15D, which is not grouped with the port 100d of the terminal 15C.

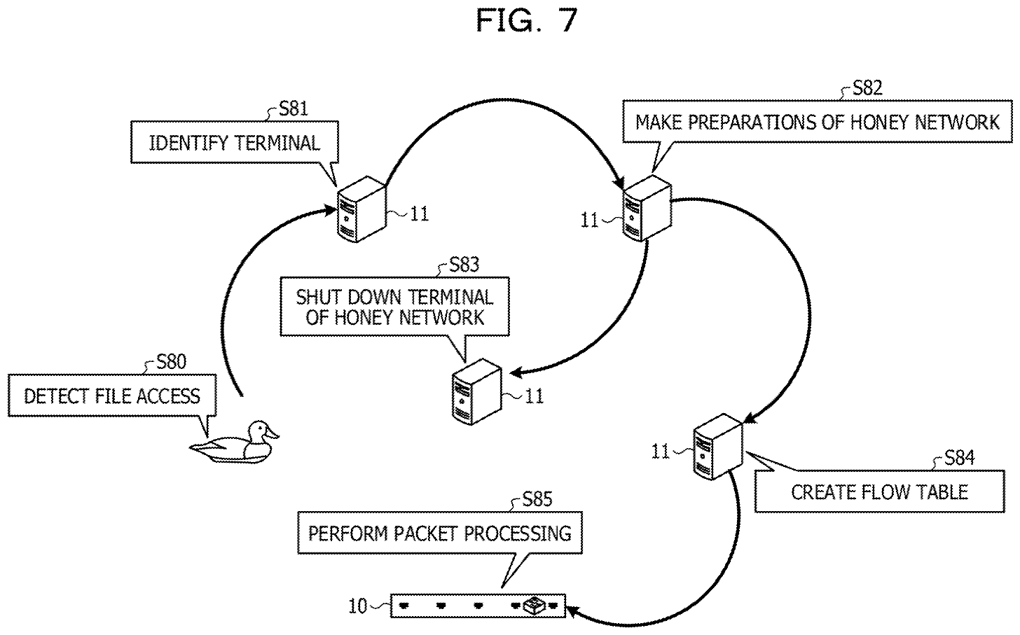

The OpenFlow controller 11 may detect the terminal 15 infected with malware and automatically isolate the detected terminal 15 into the honey network system 2. FIG. 7 is a diagram illustrating an example of an isolation procedure and, for example, is a diagram illustrating a procedure of automatically detecting and isolating the terminal 15 infected with malware.

As illustrated in FIG. 7, the OpenFlow controller 11, for example, detects a file access to a predetermined file stored, as a decoy for malware, in a file server or the like (S80). Thereby, the OpenFlow controller 11 detects that the terminal 15 in the company network system 1 has become infected with malware.

Subsequently, the OpenFlow controller 11 identifies the terminal 15 infected with malware by using a log search engine or the like (S81). Subsequently, the OpenFlow controller 11 makes preparations such as starting-up of the honey network system 2 corresponding to the company network system 1 (S82). Subsequently, the OpenFlow controller 11 shuts down the terminal 22 of the honey network system 2 corresponding to the terminal 15 identified from the inside of the company network system 1 (S83).

The process for preparations of the honey network system 2 and the process of shutting down the terminal 22 of the honey network system 2 may be performed by a controller (for example, a deception controller or a hypervisor) different from the OpenFlow controller 11.

The OpenFlow controller 11 subsequently creates the flow table 103A and the condition information 103B for logically shifting the terminal 15 infected with malware as if this terminal 15 were in the honey network system 2 (S84).

At this point, the OpenFlow controller 11 may create the condition information 103B based on a communication log for the terminal 15 infected with malware. For example, the OpenFlow controller 11 creates the condition information 103B indicating that, for nodes (the servers 14A, 14B, . . . and the terminals 15A, 15B, 15C, . . . ) that have performed communication with the terminal 15 infected with malware within a predetermined period (for example, one week or so), the destination address is not to be changed. Thereby, without changing the destination address for a node with which an attacker seems to have performed communication via the terminal 15 infected with malware, operations in such a manner that the attacker is more unaware of the operations may be performed.

Subsequently, the OpenFlow controller 11 sets the created flow table 103A and condition information 103B in the OpenFlow switch 10. Thereby, in the OpenFlow switch 10, the packet process in the deception mode (whole or part) described above is performed, so that the terminal 15C infected with malware is isolated into the honey network system 2 (S85).

Each component of each device illustrated in the drawings may not be physically configured as strictly as illustrated in the drawings. That is, the specific forms of distribution and integration of devices are not limited to those illustrated in the drawings, and all or some of the devices may be configured to be functionally or physically distributed and integrated in any units in accordance with various loads and usage states.

Regarding various processing functions performed in the OpenFlow switch 10, 10a, the OpenFlow controller 11, and the like, all or any part of the various processing functions may be executed on a CPU (or a microcomputer such as a microprocessor unit (MPU) or a microcontroller unit (MCU)). It is to be understood that all or any part of the various processing functions may be executed on programs analyzed and executed by a CPU (or a microcomputer such as an MPU or an MCU) or on hardware using wired logic.

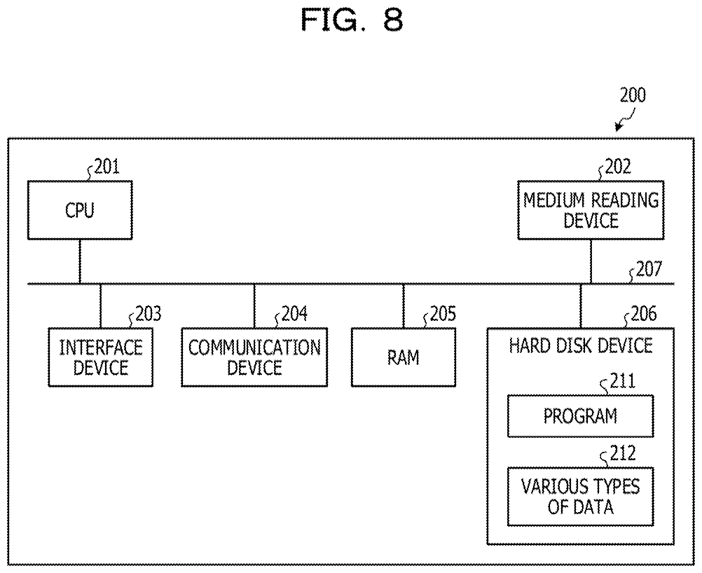

Various processes described in the above embodiments may be implemented by executing programs prepared in advance on a computer. Hereinafter, an example of a computer (hardware) that executes programs having functions similar to those of the above embodiment will be described. FIG. 8 is a block diagram illustrating an example of a hardware configuration of an information processing device (or a communication device such as the OpenFlow switch 10) according to an embodiment.

As illustrated in FIG. 8, an information processing device 200 includes a CPU 201, which executes various computation processes, and a medium reading device 202, which reads programs and the like from a recording medium. The information processing device 200 includes an interface device 203 for coupling to various devices and a communication device 204 for communicative coupling to an external device in a wired or wireless manner. The information processing device 200 includes a random-access memory (RAM) 205 that temporarily stores various types of information, and a hard disk device 206. The units (201 to 206) in the information processing device 200 are coupled to a bus 207.

In the hard disk device 206, a program 211 for performing various processes by using the receiving processing unit 102A and the sending processing unit 102B in the control unit 102 described in the above embodiment and the like is stored. Various types of data 212 that is referenced by the program 211 are stored in the hard disk device 206. The communication device 204, which is coupled to the network 13C, 13D, 21B or the like of a local area network (LAN) or the like, exchanges various types of information between devices via the network 13C, 13D, 21B.

The CPU 201 reads the program 211 stored in the hard disk device 206, loads the program 211 into the RAM 205, and executes the program 211, thereby performing various processes. The program 211 may not be required to be stored in the hard disk device 206. For example, the information processing device 200 may read and execute the program 211 stored in a readable storage medium. The storage medium readable by the information processing device 200 corresponds to, for example, a portable recording medium such as a compact disc read-only memory (CD-ROM), digital versatile disc (DVD), or Universal Serial Bus (USB) memory, a semiconductor memory such as flash memory, a hard disk drive, or the like. The program 211 may be stored in a device coupled to a public line, the Internet, a LAN, or the like, and the information processing device 200 may read the program 211 from the device and execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A malware inspection support system comprising:
one or more memories; and
one or more processors coupled to the one or more memories and the one or more processors configured to:
when a first terminal belonging to a first system is infected with malware, in response to receiving, from the first terminal, a first packet destined for a second terminal, perform determination of whether the first packet satisfies a specific condition,
when it is determined that the first packet satisfies the specific condition, change a destination address of the first packet to an address of a third terminal belonging to a second system, and
transmit the changed first packet to the third terminal.

2. The malware inspection support system according to claim 1, wherein
the second system is a honeypot system for the malware.

3. The malware inspection support system according to claim 1, wherein
the one or more processors are configured to:
when it is determined that the first packet does not satisfy the specific condition, transmit the first packet to the second terminal without changing the destination address of the first packet.

4. The malware inspection support system according to claim 1, wherein
the one or more processors are configured to:
when it is determined that the first packet does not satisfy the specific condition, determine whether the first packet is a transmission object, and
when it is determined that the first packet is not the transmission object, suspend to transmit the first packet to the second terminal.

5. The malware inspection support system according to claim 1, wherein
the determination is performed on a basis of a feature of data included in the first packet.

6. A computer-implemented malware inspection support method comprising:
when a first terminal belonging to a first system is infected with malware, in response to receiving, from the first terminal, a first packet destined for a second terminal, determining whether the first packet satisfies a specific condition;
when it is determined that the first packet satisfies the specific condition, changing a destination address of the first packet to an address of a third terminal belonging to a second system; and
transmitting the changed first packet to the third terminal.

7. The malware inspection support method according to claim 6, wherein
the second system is a honeypot system for the malware.

8. The malware inspection support method according to claim 6, further comprising:
when it is determined that the first packet does not satisfy the specific condition, transmitting the first packet to the second terminal without changing the destination address of the first packet.

9. The malware inspection support method according to claim 6, further comprising:
when it is determined that the first packet does not satisfy the specific condition, determining whether the first packet is a transmission object; and
when it is determined that the first packet is not the transmission object, suspending to transmit the first packet to the second terminal.

10. The malware inspection support method according to claim 6, wherein
the determining is performed on a basis of a feature of data included in the first packet.

11. A non-transitory computer-readable medium storing a program executable by one or more computers, the program comprising:
one or more instructions for, when a first terminal belonging to a first system is infected with malware, in response to receiving, from the first terminal, a first packet destined for a second terminal, determining whether the first packet satisfies a specific condition;
one or more instructions for, when it is determined that the first packet satisfies the specific condition, changing a destination address of the first packet to an address of a third terminal belonging to a second system; and
one or more instructions for transmitting the changed first packet to the third terminal.
